(19) United States
(12) Patent Application Publication
(10) Pub. No.: US 2024/0332921 A1
(43) Pub. Date: Oct. 3, 2024

(54) TRAVELING WAVES FOR SELECTIVE UNDERGROUND FAULT INTERRUPTION

(71) Applicant: S&C Electric Company, Chicago, IL (US)

(72) Inventor: John French, Chicago, IL (US)

(73) Assignee: S&C Electric Company, Chicago, IL (US)

(21) Appl. No.: 18/438,737

(22) Filed: Feb. 12, 2024

Related U.S. Application Data
(60) Provisional application No. 63/456,109, filed on Mar. 31, 2023.

(51) Int. Cl. H02B 1/20; H02G 9/00

(52) U.S. Cl. CPC H02B 1/202; H02G 9/00

(57) ABSTRACT

An underground power distribution network that clears faults using detected traveling waves. The network includes a power source, a feeder receiving power from the power source, and a plurality of series connected switchgear disposed along the feeder. Each switchgear includes at least one current interrupting device for interrupting current on the feeder, at least one current sensor for measuring current on the feeder, and a controller responsive to current measurement signals from the current sensor. A communications link provides communications between the controllers. The current sensors detect traveling waves as a result of a fault on the feeder and the controllers broadcast messages on the communications link identifying whether the controller receives positive polarity or negative polarity traveling waves that identify whether the fault is downstream or upstream of the switchgear so as to determine which current interrupting device will be opened to clear the fault.

### CROSS-REFERENCE TO RELATED APPLICATION

This application claims the benefit of priority from the U.S. Provisional Application No. 63/456,109, filed on Mar. 31, 2023, the disclosure of which is hereby expressly incorporated herein by reference for all purposes.

### BACKGROUND

### Field

The present disclosure relates generally to a system and method for clearing a fault in a power distribution network by detecting the direction of traveling waves in series connected switchgear.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeder lines that carry the same current but are 120° apart in phase. three-phase and single-phase lateral lines are tapped off of the feeder that provide the medium voltage to various distribution transformers, where the voltage is stepped down to a low voltage and is provided to loads, such as homes, businesses, etc.

Periodically, faults occur in the distribution network as a result of various things, such as animals touching the lines, lightning strikes, tree branches falling on the lines, vehicle collisions with utility poles, etc. Faults may create a short-circuit that increases the stress on the network, which may cause the current flow to significantly increase, for example, many times above the normal current, along the fault path. This amount of current causes the electrical lines to significantly heat up and possibly melt, and also could cause mechanical damage to various components in the network. These faults are often transient or intermittent faults as opposed to a persistent or bolted fault, where the thing that caused the fault is removed a short time after the fault occurs, for example, a lightning strike. In such cases, the distribution network will almost immediately begin operating normally after a brief disconnection from the source of power.

Power distribution networks of the type referred to above typically include switching devices, breakers, reclosers, current interrupters, etc. that control the flow of power throughout the network. Standalone pad mounted and underground switchgear including electrical disconnect switches, fuses and/or circuit breakers used to control, protect and isolate electrical equipment are often employed to de-energize equipment to allow work to be done and to clear faults.

Reclosers and other related devices that employ fault interrupters are often provided as protection devices on utility poles. These reclosers typically detect the current and/or voltage on the line to monitor current flow and have controls that indicate problems with the network circuit, such as detecting a high current fault event. If such a high fault current is detected the recloser is opened in response thereto, and then after a short delay closed to determine whether the fault is a transient fault. If high fault current flows when the recloser is closed after opening, it is immediately re-opened. If the fault current is detected a second time, or multiple times, during subsequent opening and closing operations indicating a persistent fault, then the recloser remains open and it may drop out of its mounting or provide another form of indication that it is locked open, where the time between detection tests may increase after each test.

Some power distribution networks may employ underground circuits that feed residential and commercial customers. Often times these circuits are configured in a loop and fed from power sources at both ends, where an open circuit location is used in the circuit to isolate the two power sources. These loop circuits sometimes include homes or businesses that have power generation capabilities, for example, through generators, photovoltaic cells, wind turbines, battery modules, etc., known generally as distributed power generation, where self-powered individual homes, groups of homes or businesses that are not connected to the grid is often referred to as islanding.

A successful fault protection scheme for an underground distribution network should provide high-speed and selective fault clearing capabilities. Selectively coordinating protection devices ensures the protection device nearest the fault operates to isolate the faulted segment leading to optimal reliability improvements with any switchgear configuration. The need for fast fault clearing in underground circuits is necessary because those circuits are often shorter in length and having a shorter reactance per unit length than overhead circuits, which typically results in high fault currents through the underground circuit. These high fault currents challenge protection coordination and require fast protection device clearing to minimize arc flash incident energy levels and equipment damage. Therefore, protecting an underground circuit provides challenges that are not significant for protecting overhead circuits.

The number of series coupled protection devices that can be selectively coordinated using traditional time-overcurrent methods is generally limited to three devices. Utilities often deploy more than three devices capable of current interruption in series along a feeder, but typically not every device will serve a protection function.

A traveling wave is an electromagnetic pulse having both a voltage and current component that propagates down a conductor in response to an abrupt change in voltage, where the wavelength of the pulse is much shorter than the length of the conductor, the propagation speed of the pulse is much faster than the 60 Hertz current cycle of a typical distribution network, and the pulse can have a frequency in the range of a few megahertz to 10s of megahertz. Therefore, when a fault occurs on a power line a traveling wave is launched from the fault location in both directions along the line, and is able to be detected by, for example, a current sensor in a protection device well before the current sensor detects the fault current.

The use of detecting traveling waves for circuit protection relaying technology has been successful in transmission systems where only a two terminal system needs protecting. However, limitations and challenges occur when extending traveling wave technology for circuit protection to distribution systems having shorter circuit lengths including requiring higher signal sampling rates and higher accuracy clock synchronization in double-ended traveling wave detection schemes. More specifically, a feeder may have a certain number of reclosers disposed along its length and laterals tapped from the feeder between adjacent reclosers, where each tap may be protected by a fuse. If a fault occurs on one of those laterals a traveling wave is launched from the fault location that can be detected by the adjacent reclosers. However, it is difficult to impossible with state-of-the art technology to determine at the reclosers that the fault is located on the lateral or the feeder using traveling wave detection. Therefore, it can't be determined whether the upstream recloser should open because the fault is on the feeder or whether the recloser should remain closed and let the particular fuse operate because the fault is on a lateral line.

### SUMMARY

The following discussion discloses and describes an underground power distribution network that clears faults using detected traveling waves. The network includes a power source, a feeder receiving power from the power source, and a plurality of series connected switchgear disposed along and electrically coupled to the feeder. Each switchgear includes at least one current interrupting device for interrupting current on the feeder, at least one current sensor for measuring current on the feeder, and a controller responsive to current measurement signals from the current sensor. A communications link provides communications between the controllers. The current sensors detect traveling waves as a result of a fault on the feeder and the controllers broadcast messages on the communications link identifying whether the controller receives positive polarity or negative polarity traveling waves that identify whether the fault is downstream or upstream of the switchgear so as to determine which current interrupting device will be opened to clear the fault.

Additional features of the disclosure will become apparent from the following description and appended claims, taken in conjunction with the accompanying drawings.

### BRIEF DESCRIPTION OF THE DRAWINGS

FIG. 1 is a simplified schematic type diagram of an underground power distribution network that detects traveling waves for fault clearing;

FIG. 2 is a graph with time on the horizontal axis and current magnitude on the vertical axis showing a fault current wave and traveling waves;

FIG. 3 is a graph with time on the horizontal axis and current magnitude on the vertical axis showing detail of the traveling waves shown in the graph of FIG. 2; and

FIG. 4 is a simplified schematic type diagram of another underground power distribution network that detects traveling waves for fault clearing.

### DETAILED DESCRIPTION OF THE EMBODIMENTS

The following discussion of the embodiments of the disclosure directed to a system and method clearing a fault in an underground power distribution network by detecting traveling waves is merely exemplary in nature, and is in no way intended to limit the invention or its applications or uses. For example, as mentioned, the system and method have particular application for underground power distribution networks. However, the system and method may have other applications.

This disclosure proposes employing traveling wave technology for a fault protection scheme in an underground power distribution circuit. The point-to-point nature of switchgear in underground circuits provides an avenue for using traveling wave applications because of the similarity to two-terminal transmission systems. In other words, because the laterals tapped from a feeder in an underground network are in groups, where each group is generally tapped from the feeder at a certain switchgear, the drawback of having lateral taps distributed along the feeder between reclosers in an overhead circuit is removed. Further, because the power lines are designed for underground use, the propagation speed of the traveling wave is slower than traveling waves propagating on lines designed for overhead power distribution. With adequate sensing and instrumentation on the feeder and tapped laterals of switchgear, directional interlocking techniques can be applied to detect the arrival of a traveling wave and directionally locate the source of a fault. Providing a sensor on each tapped lateral and at least one sensor on the feeder, the direction of the fault can be determined and the appropriate fault interrupting device on the feeder or the tap can operate.

The proposed traveling wave based protection scheme would function similar to known directional interlocking schemes, but the proposed scheme would use traveling waves to determine fault directionality instead of phasor-based directional overcurrent. Also, the proposed traveling wave based protection scheme could detect a fault and determine its direction faster since a reliable phasor calculation can take over one power system cycle. Further, the proposed traveling wave based protection scheme can successfully coordinate series connected underground devices using traveling waves and a communications scheme without using time-graded coordination.

In one embodiment, a high-speed and low latency communications link, such as fiber optics and generic object oriented substation event (GOOSE) messaging, between the protection devices can share the upstream/downstream fault determination between the devices. This type of communications scheme would allow for a theoretically limitless number of protection devices placed in series and eliminate the need for time-graded coordination of the devices. The proposed traveling wave based protection scheme could achieve <1 ms fault detection times and still ensure that the device nearest to the fault operates first, thus achieving selectivity. Having a protection scheme of the type discussed herein mitigates the risk of falling fault current levels that challenge traditional overcurrent coordination as a green energy transition means larger penetration of distributed energy resources (DERs) and less spinning synchronous generators that would typically provide the high fault currents.

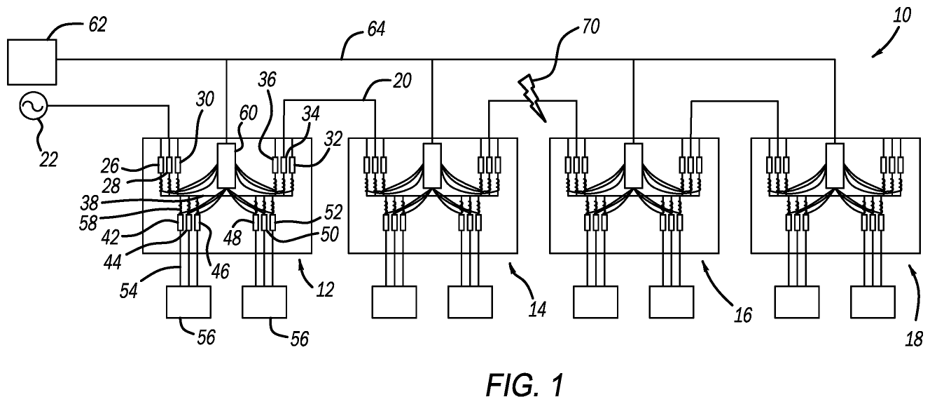

FIG. 1 is a simplified schematic type diagram of an underground power distribution network 10 including four switchgear 12, 14, 16 and 18 electrically coupled in series to and disposed along a three-phase feeder 20, where the feeder 20 receives power from an AC source 22, such as a substation. It is noted that the term switchgear as used herein is intended to represent any suitable assembly of electrical components that include protection switching devices, where the configuration of the switchgear 12-18 as shown and described below is one design that is suitable for the discussion herein. However, other switchgear designs would also be applicable. One end of each of three automated interrupting devices 26, 28 and 30 is coupled to one of the phases of the feeder 20 at the upstream or source side of each switchgear 12-18, and one end of each of three automated interrupting devices 32, 34 and 36 is coupled to the feeder 20 at the downstream or load side of the switchgear 12-18. The other end of the devices 26-36 is coupled to one of the phases of a three-phase bus bar 38 in the switchgear 12-18, where one of the devices 26-30 and one of the devices 32-36 are coupled to the same phase. The automated interrupting devices 26-36 can be any switching device suitable for the purposes discussed herein, such as a recloser.

Depending on whether a fault on the feeder 20 is a line-to-line fault, line-to-ground fault, etc., one or more of the devices 32-36 may open to clear the fault if the fault is on the downstream side of the particular switchgear 12-18. One or more of the devices 26-30 may open to clear the fault if the fault is on the bus bar 38 in the particular switchgear 12-18 and depending on what phases are affected by the fault. Further, if the network 10 is reconfigured so that the source of power comes from a different location and the upstream and downstream sides of the switchgear 12-18 are reversed, then the devices 26-30 operate to clear faults on the feeder 20 and the devices 32-36 operate to clear faults on the bus bar 38.

One end of each of three automated interrupting devices or fuses 42, 44 and 46 is coupled to one of the phases of the bus bar 38 at the upstream side of each switchgear 12-18, and one end of each of three automated interrupting devices or fuses 48, 50 and 52 is coupled to one of the phases of the bus bar 38 at the downstream side of each switchgear 12-18, where one of the devices 42-46 and one of the devices 48-52 are coupled to the same phase. The other end of each of the devices or fuses 42-52 is coupled to a separate single-phase lateral line 54 that is also coupled to loads 56 in a manner well understood by those skilled in the art.

Each of the devices 26-36 and the devices or fuses 42-52 include a current sensor 58 that provides a current measurement signal to a switchgear controller 60, where the controller 60 controls the open or closed position of the devices 26-36 and the open and closed position of the devices or fuses 42-52 if they are automated devices and not fuses. The controller 60 employs the necessary components for high speed signal detection including high speed analog-to-digital converters (ADCs). Each of the controllers 60 is in communication with a central controller 62 on a fiber optics line 64, or other suitable high speed communications line, where the central controller 62 can be located at any suitable location, such as at the substation or somewhere along the feeder 20. The current sensors 58 can be any current sensor suitable for detecting traveling waves, such as current transducers which commonly have signal bandwidth in the range of several tens of megahertz. Thus, for the non-limiting embodiment being discussed herein, each switchgear 12-18 includes twelve current sensors 58, namely, three current sensors 58 for each phase at the upstream side of the switchgear 12-18, three current sensors 58 for each phase at the downstream side of the switchgear 12-18, and a current sensor 58 on each of the lateral lines 54.

The network 10 employs a coordinated protection scheme so that the proper current interrupting device is opened depending on the location of a fault in the network 10. All of the current sensors 58 provide current measurement signals to the controller 60 along with the sensors identification. The controller 60 is configured and programmed so that those signals are processed to determine if the signal is a result of a traveling wave. If so, the arrival time of the signal at the controller 60 is time stamped and the information about the traveling wave and the sensor 58 that detected the traveling wave is sent to the controller 62 on the line 64. The controller 62 processes all of the time-stamped signals and sends a signal back to the controllers 60 instructing one of them to open the proper device or devices 26-36 to clear the fault so that a minimal number of the loads 56 is affected by loss of power. The critical information that is needed is whether the traveling wave is received by a switchgear 12-18 in a downstream or upstream direction so that the segment of the line 20 having the fault can be identified between adjacent switchgear 12-18. In an alternate embodiment, one of the controllers 60 in one of the switchgear 12-18 is configured as a master controller that provides the same operation as the central controller 62.

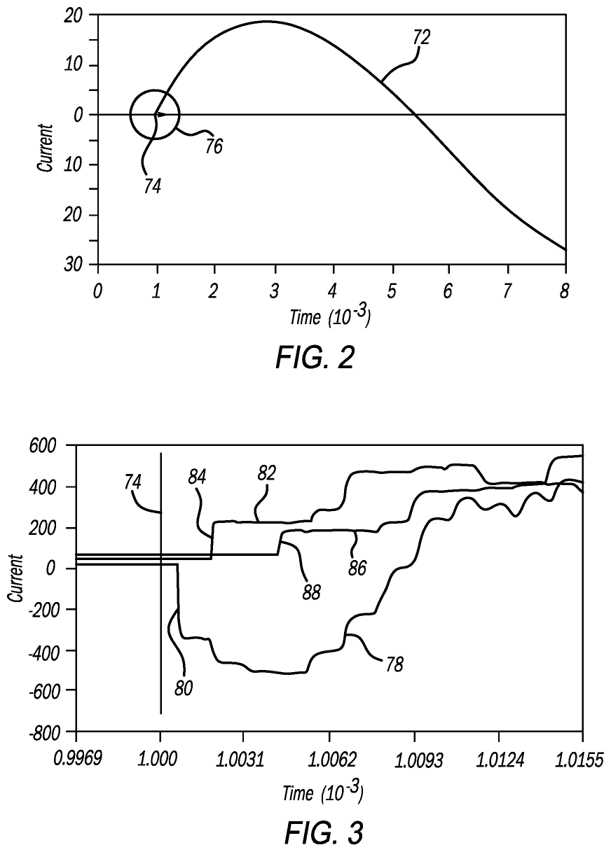

An example is provided below with reference to FIGS. 2 and 3 that are graphs with time on the horizontal axis and current magnitude on the vertical axis showing measured current for a line-to-ground fault that occurs on one of the phases of the feeder 20 at location 70 between the switchgear 14 and 16, but closer to the switchgear 16, where a traveling wave will be launched in both directions on that phase of the feeder 20 in response to the fault. FIG. 2 shows the fault current wave 72 that originates from the fault at time 74, where section 76 is blown up in the graph shown in FIG. 3 to illustrate the traveling waves. For the fault at the location 70 being discussed herein, only one of the detected traveling waves at the switchgear 12-16 is discussed, where other sensors 58 in the switchgear 12-18 may also detect the traveling wave, which is processed consistent with the discussion herein.

The current sensor 58 associated with the device 26-30 coupled to the phase that is faulted in the switchgear 16 detects a traveling wave 78 first at time 80 because the switchgear 16 is closest to the fault, which has a negative polarity because the fault is upstream of the switchgear 16. The current sensor 58 associated with the device 32-36 coupled to the phase that is faulted in the switchgear 14 detects a traveling wave 82 later at time 84, which has a positive polarity because the fault is downstream of the switchgear 14. The current sensor 58 associated with the device 32-36 coupled to the phase that is faulted in the switchgear 12 detects a traveling wave 86 later at time 88, which has a positive polarity because the fault is downstream of the switchgear 12. The controllers 60 in the switchgear 12-16 send the information of the detected traveling waves 78, 82 and 86 on the line 64 to the controller 62 that processes the information to determine which of the devices 26-36 should be opened to clear the fault using the information that the fault is located downstream of one switchgear 12-18 and upstream of an adjacent switchgear 12-18. The controller 62 then sends a message back to the proper controller 60 to cause that controller 60 to open the proper device. In this example, the controller 60 in the switchgear 14 opens the device 32-36 associated with the phase on the feeder 20 that is faulted.

If the fault is on one of the lateral lines 54, then the current sensor 58 for the device or fuse associated with that line 54 will detect the traveling wave first, which the controller 60 will know, and will open the device 42-52 if it is an automated device or allow the fuse 42-52 to operate if it is a fuse. The other sensors 58 may also detect the traveling wave depending on how far they are from the line 54 having the fault, and that information may be sent to the central controller 62, but the controller 62 will not instruct a particular controller 60 to open a current interrupting device because it will know what sensor 58 received the traveling wave first.

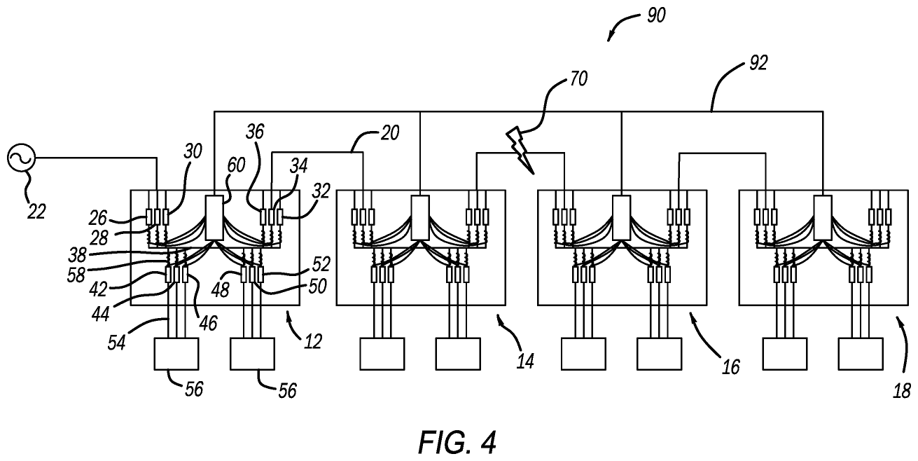

In an alternate embodiment, the controllers 60 are in communication with each other so that the central controller 62 is not needed. FIG. 4 is a simplified schematic type diagram of an underground power distribution network 90 illustrating this embodiment, where like elements to the network 10 are identified by the same reference number. In this embodiment, a fiber optics line 92, or other suitable high speed communications line, is coupled to the controller 60 in each switchgear 12-18 and provides a communications link therebetween. The controllers 60 tell each other that they have received a traveling wave and the direction it was received from based on the wave's polarity. For the example discussed herein, the controller 60 in the switchgear 12 will receive a message from the switchgear 14 telling it that the traveling wave was launched downstream of the switchgear 14, so it will not open any interrupting devices. The controller 60 in the switchgear 14 will know that the traveling wave was launched downstream of it and will receive a message from the switchgear 16 telling it that the traveling wave was launched upstream of the switchgear 16, so the controller 60 in the switchgear 14 will open the appropriate device 32-36 depending on what phase on the feeder 20 has been faulted.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A power distribution network comprising:
a power source:
a main power line receiving power from the power source;
a plurality of switchgear disposed along and electrically coupled to the main power line, each switchgear including at least one current interrupting device for interrupting current on the main power line, at least one current sensor for measuring current on the main power line, and a switchgear controller responsive to current measurement signals from the at least one current sensor; and
a communications link providing communications between the switchgear controllers in the plurality of switchgear, wherein the at least one current sensor in the plurality of switchgear detects traveling waves as a result of a fault on the main power line and the switchgear controllers broadcast messages on the communications link identifying whether the switchgear controller receives positive polarity or negative polarity traveling waves that identify whether the fault is downstream or upstream of the switchgear so as to determine which current interrupting device will be opened to clear the fault.

2. The network according to claim 1 further comprising a central controller, wherein the switchgear controllers provide messages to the central controller identifying when the at least one current sensor detects a traveling wave and its polarity, the central controller instructing one of the switchgear controllers to open at least one of the current interrupting devices based on when the traveling waves are detected and their polarity.

3. The network according to claim 1 wherein one of the switchgear controllers is a master controller, and wherein the switchgear controllers provide messages to the master controller identifying when the at least one current sensor detects a traveling wave and its polarity, the master controller instructing one of the switchgear controllers to open at least one of the current interrupting devices based on when the traveling waves are detected and their polarity.

4. The network according to claim 1 wherein the main power line is a three-phase power line and each switchgear includes at least one current interrupting device for each phase and a current sensor for each current interrupting device, and wherein the at least one current interrupting device to be opened to clear the fault depends on which phase is affected by the fault.

5. The network according to claim 4 wherein each switchgear includes an upstream current interrupting device and a downstream current interrupting device for each phase.

6. The network according to claim 1 further comprising a plurality of lateral lines tapped off of the main power line in each switchgear, each switchgear further including a current interrupting device or a fuse and a current sensor for each lateral line, the current sensor for each lateral line detecting traveling waves from a fault on the lateral line, wherein the switchgear controller opens the current interrupting device or allows the fuse to operate on the lateral line if it detects a traveling wave on that lateral line so that other current interrupting devices in the network don't open.

7. The network according to claim 1 wherein the network is an underground power distribution network.

8. The network according to claim 1 wherein the communications link is a fiber optics link.

9. The network according to claim 1 wherein the current sensors are current transformers.

10. The network according to claim 1 wherein the plurality of switchgear is more than three switchgear.

11. An underground power distribution network comprising:
a power source:
a three-phase feeder receiving power from the power source;
a plurality of switchgear disposed along and electrically coupled to the feeder, each switchgear including at least one current interrupting device for each phase for interrupting current on the feeder, a current sensor for each current interrupting device for measuring current on the feeder, and a switchgear controller responsive to current measurement signals from the current sensors in the switchgear; and
a communications link providing communications between the switchgear controllers in the plurality of switchgear, wherein the current sensors in the plurality of switchgear detect traveling waves as a result of a fault on the feeder and the switchgear controllers broadcast messages on the communications link identifying whether the switchgear controller receives positive polarity or negative polarity traveling waves that identify whether the fault is downstream or upstream of the switchgear so as to determine which current interrupting device will be opened to clear the fault.

12. The network according to claim 11 further comprising a central controller, wherein the switchgear controllers provide messages to the central controller identifying when the current sensors detect a traveling wave and its polarity, the central controller instructing one of the switchgear controllers to open at least one of the current interrupting devices based on when the traveling waves are detected and their polarity.

13. The network according to claim 11 wherein one of the switchgear controllers is a master controller, and wherein the switchgear controllers provide messages to the master controller identifying when the current sensors detect a traveling wave and its polarity, the master controller instructing one of the switchgear controllers to open at least one of the current interrupting devices based on when the traveling waves are detected and their polarity.

14. The network according to claim 11 wherein each switchgear includes an upstream current interrupting device and a downstream current interrupting device for each phase.

15. The network according to claim 11 further comprising a plurality of lateral lines tapped off of the feeder in each switchgear, each switchgear further including a current interrupting device or a fuse and a current sensor for each lateral line, the current sensor for each lateral line detecting traveling waves from a fault on the lateral line, wherein the switchgear controller opens the current interrupting device or allows the fuse to operate on the lateral line if it detects a traveling wave on that lateral line so that other current interrupting devices in the network don't open.

16. The network according to claim 11 wherein the plurality of switchgear is more than three switchgear.

17. An underground power distribution network comprising:
a power source:
a three-phase feeder receiving power from the power source;
a plurality of switchgear disposed along and electrically coupled to the feeder;
a plurality of lateral lines tapped off of the feeder in each switchgear, each switchgear including an upstream current interrupting device and a downstream current interrupting device for each phase for interrupting current on the feeder, a current interrupting device or a fuse for each lateral line, a current sensor for each current interrupting device or fuse for measuring current on the feeder and the lateral lines, and a switchgear controller responsive to current measurement signals from the current sensors in the switchgear; and
a communications link providing communications between the switchgear controllers in the plurality of switchgear, wherein the current sensors in the plurality of switchgear detect traveling waves as a result of a fault on the feeder or a lateral line and the switchgear controllers broadcast messages on the communications link identifying whether the switchgear controller receives positive polarity or negative polarity traveling waves that identify whether the fault is downstream or upstream of the switchgear so as to determine which current interrupting device will be opened to clear the fault, and wherein the switchgear controller opens the current interrupting device or allows the fuse to operate on the lateral line if it detects a traveling wave on that lateral line so that other current interrupting devices in the network don't open.

18. The network according to claim 17 further comprising a central controller, wherein the switchgear controllers provide messages to the central controller identifying when the current sensors detect a traveling wave and its polarity, the central controller instructing one of the switchgear controllers to open at least one of the current interrupting devices based on when the traveling waves are detected and their polarity.

19. The network according to claim 17 wherein one of the switchgear controllers is a master controller, and wherein the switchgear controllers provide messages to the master controller identifying when the current sensors detect a traveling wave and its polarity, the master controller instructing one of the switchgear controllers to open at least one of the current interrupting devices based on when the traveling waves are detected and their polarity.

20. The network according to claim 17 wherein the plurality of switchgear is more than three switchgear.
